(19) United States
(12) Patent Application Publication
(10) Pub. No.: US 2025/0154037 A1
(43) Pub. Date: May 15, 2025

(54) INTEGRATED SYNCHRONOUS NITROGEN AND SULFUR REMOVAL DEVICE AND WASTEWATER TREATMENT METHOD

(71) Applicant: Chongqing University, Chongqing (CN)

(72) Inventors: You-Peng CHEN, Chongqing (CN); Bin-Hao ZHU, Chongqing (CN); Peng YAN, Chongqing (CN); Yu SHEN, Chongqing (CN); Hui-Min FU, Chongqing (CN); Man-Yi SHI, Chongqing (CN)

(21) Appl. No.: 18/637,097

(22) Filed: Apr. 16, 2024

(30) Foreign Application Priority Data
Nov. 10, 2023 (CN) 202311496561.0

(51) Int. Cl. C02F 3/00; C02F 3/30; C02F 101/10; C02F 101/16; C02F 103/20

(52) U.S. Cl. CPC C02F 3/005; C02F 3/302; C02F 2101/101; C02F 2101/163; C02F 2103/20; C02F 2201/005; C02F 2209/44

(57) ABSTRACT

An integrated synchronous nitrogen and sulfur removal device and a wastewater treatment method includes a reactor. A partition plate is horizontally arranged in the reactor to divide the reactor into a first reaction area and a second reaction area which are arranged up and down. An annular baffle plate with a height is arranged in the first reaction area to divide the first reaction area into a first reaction chamber and a second reaction chamber, and a hollow columnar carrier is arranged in the first reaction chamber, so that a third reaction chamber is formed in the first reaction chamber, and the hollow columnar carrier is made of biological stuffing. A water inlet of the reactor is arranged above the first reaction chamber, an anode and a cathode are arranged in the third reaction chamber.

### TECHNICAL FIELD

The present disclosure belongs to the technical field of wastewater treatment, relates to aquaculture wastewater, in particular to an integrated synchronous nitrogen and sulfur removal device and method.

### BACKGROUND

Wastewater treatment refers to process of purifying wastewater to meet water quality requirements for being discharged into a water body or reused. Wastewater treatment is widely used in construction, agriculture, transportation, energy, petrochemical, environmental protection, urban landscape, medical treatment, catering and other fields. Due to different physical and chemical properties of wastewater produced in different industries, if a unified process is adopted in the process of treatment and purification, the treatment effect may not be ideal and the requirements for discharge or reuse cannot be met. Therefore, it is very important to design specific treatment processes for wastewater of different properties in different industries.

The industrialized recirculation aquaculture system (RAS) has been developed rapidly due to its advantages of water saving, small land occupation, high aquaculture efficiency, and low environmental pollution. However, in the process of aquaculture, fish excrement, residual bait, and plankton debris can easily lead to excessive content of nitrogen and sulfur (nitrogen includes ammonium and nitrate, and sulfur refers to sulfate) in aquaculture water, if not treated in time, the excessive content of nitrogen and sulfur will lead to the death of fish. However, the content of dissolved oxygen in aquaculture wastewater is high, the wastewater is difficult to be treated by traditional aerobic nitrification and anaerobic denitrification wastewater treatment process, and sulfate can not be removed by the process of aerobic denitrification. If water is replaced, the economic cost would be increased.

### SUMMARY

Aiming at the above shortcomings in the prior art, a purpose of the present disclosure is to provide an integrated synchronous nitrogen and sulfur removal device and a wastewater treatment method. In the present disclosure, nitrogen and sulfur can be synchronously removed, the recovery of elemental sulfur can be achieved, and the economic cost can be reduced.

The technical solution of the present disclosure is implemented as follows:

An integrated synchronous nitrogen and sulfur removal device includes a reactor, a partition plate is horizontally arranged in the reactor to divide the reactor into upper and lower areas, wherein the upper area above the partition plate is a first reaction area, and the lower area below the partition plate is a second reaction area. An annular baffle plate with a height is arranged in the first reaction area, and a lower end of the annular baffle plate is fixed with the partition plate, so that the first reaction area is divided into two chambers, that is, a first reaction chamber and a second reaction chamber from inside to outside. A hollow columnar carrier is arranged in the first reaction chamber, a top end of the hollow columnar carrier is closed, and a lower end of the hollow columnar carrier is fixed with the partition plate, so that a third reaction chamber is formed in the first reaction chamber, and the hollow columnar carrier is made of biological stuffing.

A water inlet of the reactor is formed above the first reaction chamber to facilitate entry of wastewater into the first reaction chamber, and some sulfate and ammonium in the first reaction chamber are diffused into the third reaction chamber. An anode and a cathode are arranged in the third reaction chamber, and the anode and the cathode are connected with positive and negative electrodes of a direct-current power supply, respectively, to facilitate reduction of sulfide produced by sulfate radical reduction into elemental sulfur.

Several water holes are formed in portions of the partition plate corresponding to the second reaction chamber and the first reaction chamber corresponding to an outer side of the hollow columnar carrier to facilitate wastewater in the first reaction chamber to enter the second reaction chamber through the second reaction area, aeration equipment is arranged in the second reaction chamber, and a water outlet is formed in an upper part of a side wall of the reactor corresponding to the second reaction chamber to facilitate discharge of treated wastewater.

Further, a corresponding part of the reactor below the partition plate is in an inverted cone shape, a sludge discharge port is formed in a bottom of the reactor for discharging residual sludge in the reactor, and a control valve is arranged at the sludge discharge port for controlling opening and closing of the sludge discharge port.

Further, the second reaction chamber is filled with suspended biological stuffing.

Further, the hollow columnar carrier is arranged in the corresponding first reaction chamber inside the annular baffle plate through a base.

A wastewater treatment method for treating wastewater with high content of dissolved oxygen using the integrated synchronous nitrogen and sulfur removal device as mentioned above includes the following steps: enabling wastewater to enter the first reaction chamber from above the reactor, removing nitrate in the wastewater, enabling some sulfate and ammonium in the wastewater in the first reaction chamber to enter the third reaction chamber for removal, enabling residual ammonium in the first reaction chamber to flow through the second reaction area and enter the second reaction chamber for removal.

Further, at initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

Further, wall thickness d of the hollow columnar carrier and hydraulic retention time t of the wastewater in the anoxic area should meet following requirement: d is greater than or equal to Kt, wherein d is in cm, tis in h, K is a constant in cm/h, and taken as 5.

Compared with the prior art, the present disclosure achieves the following beneficial effects.

Firstly, in the present disclosure, the reactor includes an anoxic area, an anaerobic area, and an aerobic area. When wastewater enters the anoxic area, nitrate can be removed. Some ammonium and sulfate in the anoxic area enter the anaerobic area due to concentration differences. In the anaerobic area, with anaerobic sulfate reducing bacteria, sulfate are reduced into sulfide, and the sulfide are converted into elemental sulfur under the action of current and enriched on the anode. Sulfur can be removed from wastewater by removing the anode to recover elemental sulfur. In the oxygen consumption metabolism process of anaerobic microorganisms in the anaerobic area, ammonium entering the anaerobic area can be effectively removed. The residual ammonium can be effectively removed by entering the aerobic area through the second reaction area, so that the purpose of synchronous nitrogen and sulfur removal is achieved.

Secondly, in the present disclosure, the second reaction area is not only an area for collecting residual sludge in the anoxic area and the aerobic area, but also a multi-niche mixed living area of aerobic microorganisms, anoxic microorganisms, and anaerobic microorganisms, which is beneficial for nitrogen removal.

Thirdly, in the present disclosure, the reactor is of an integrated structure, the area occupied by wastewater treatment equipment can be effectively reduced, and the construction investment cost is reduced.

### BRIEF DESCRIPTION OF THE DRAWINGS

FIG. 1 is a structural schematic diagram of an integrated synchronous nitrogen and sulfur removal device in the present disclosure.

Reference signs: 1 reactor; 2 water outlet; 3 annular baffle plate; 4 hollow columnar carrier; 5 base; 6 partition plate; 7 control valve; 8 anode; 9 cathode; and 10 direct-current power supply.

### DETAILED DESCRIPTION OF THE EMBODIMENTS

The following is further described in detail for the present disclosure in combination with the drawings and embodiments.

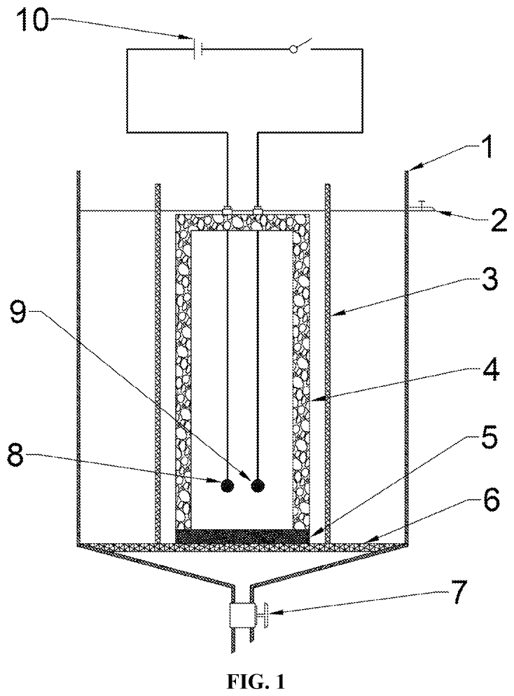

Referring to FIG. 1, an integrated synchronous nitrogen and sulfur removal device includes a reactor 1, a partition plate 6 is horizontally arranged in the reactor 1 to divide the reactor 1 into upper and lower areas, wherein the upper area above the partition plate 6 is a first reaction area, and the lower area below the partition plate 6 is a second reaction area. An annular baffle plate 3 with a height is arranged in the first reaction area, and a lower end of the annular baffle plate 3 is fixed with the partition plate 6, so that the first reaction area is divided into two chambers, that is, a first reaction chamber and a second reaction chamber from inside to outside. A hollow columnar carrier 4 is arranged in the first reaction chamber, a top end of the hollow columnar carrier 4 is closed, and a lower end of the hollow columnar carrier 4 is fixed with the partition plate 6, so that a third reaction chamber is formed in the first reaction chamber, and the hollow columnar carrier 4 is made of biological stuffing.

A water inlet of the reactor 1 is formed above the first reaction chamber to facilitate the entry of wastewater into the first reaction chamber, and some sulfate and ammonium in the first reaction chamber are diffused into the third reaction chamber. An anode 8 and a cathode 9 are arranged in the third reaction chamber, and the anode 8 and the cathode 9 are connected with positive and negative electrodes of a direct-current power supply 10, respectively, to facilitate the reduction of sulfide produced by sulfate radical reduction into elemental sulfur.

Several water holes are formed in portions of the partition plate 6 corresponding to the second reaction chamber and the first reaction chamber corresponding to an outer side of the hollow columnar carrier 4 to facilitate wastewater in the first reaction chamber to enter the second reaction chamber through the second reaction area, aeration equipment (not shown in figures) is arranged in the second reaction chamber, and a water outlet 2 is formed in an upper part of a side wall of the reactor 1 corresponding to the second reaction chamber to facilitate the discharge of treated wastewater.

In this way, wastewater enters the first reaction chamber of the reactor, and a biological membrane is adhered and grown on a surface of the hollow columnar carrier to consume dissolved oxygen in the wastewater, making the first reaction chamber corresponding to an outer side of the hollow columnar carrier become an anoxic area, and the third reaction chamber corresponding to an inner side of the hollow columnar carrier become an anaerobic area. In the anoxic area, some nitrate in the wastewater can be removed by denitrifying bacteria. Subsequently, some sulfate and ammonium in the first reaction chamber can enter the third reaction chamber, and the residual dissolved oxygen and nitrate are blocked and completely consumed by a large number of aerobic bacteria and denitrifying bacteria grown on the hollow columnar carrier. In the third reaction chamber, anaerobic sulfate reducing bacteria can reduce sulfate to sulfide, and finally sulfide can be enriched in the anaerobic area. Then, the direct-current power supply is turned on, and the sulfide can be converted into elemental sulfur under the action of current and enriched on the anode. By removing the anode, sulfur can be removed from the wastewater, and elemental sulfur on the electrode can be recovered. In process of oxygen consumption metabolism of anaerobic microorganisms, ammonium entering the third reaction chamber can be effectively removed. Furthermore, due to the decrease in the concentration of sulfate and ammonium in the anaerobic area, sulfate and ammonium in the anoxic area can be continuously diffused into the anaerobic area due to concentration difference.

The residual ammonium and nitrate in the wastewater in the first reaction chamber enter the second reaction area. The second reaction area is a multi-niche mixed living area of aerobic microorganisms, anoxic microorganisms, and anaerobic microorganisms, which is beneficial for nitrogen removal. Then, the wastewater enters the second reaction chamber. Aeration equipment is arranged in the second reaction chamber, making the area become an aerobic area. The residual ammonium is oxidized into nitrate, and the nitrate is degraded by aerobic denitrifying bacteria to produce nitrogen to be discharged, thus achieving the removal of ammonium in the wastewater.

In addition, the anode and the cathode in the third reaction chamber are connected with the positive and negative electrodes of the direct-current power supply, respectively, so through holes for a circuit and the electrodes to pass through are formed in a top of the hollow columnar carrier. The water outlet is located above an upper part of the hollow columnar carrier to ensure that the hollow columnar carrier is completely immersed in the wastewater and air is avoided from making contact with the hollow columnar carrier. Moreover, in order to avoid the wastewater in the anoxic area from entering the anaerobic area through the through holes, detachable sealing mechanisms are arranged at the through holes, and a power switch is arranged on the circuit.

In this embodiment, a corresponding part of the reactor 1 below the partition plate 6 is in an inverted cone shape, a sludge discharge port is formed in a bottom of the reactor 1 for discharging residual sludge in the reactor 1, and a control valve 7 is arranged at the sludge discharge port for controlling opening and closing of the sludge discharge port.

In this embodiment, the second reaction area is arranged in an inverted cone shape to facilitate the collection of residual sludge in the anoxic area of the first reaction chamber and the second reaction chamber, and the sludge is discharged from the sludge discharge port. For the sludge in the anaerobic area, its amount is very small and can be pumped out regularly.

In this embodiment, the second reaction chamber is filled with suspended biological stuffing (not shown in figures) to facilitate the biological membrane on which the suspended biological stuffing is adhered and grown to make full contact with the wastewater, thus improving the effect of wastewater treatment.

In this embodiment, the hollow columnar carrier 4 is arranged in the corresponding first reaction chamber inside the annular baffle plate 3 through a base 5. Thus, the lower end of the hollow columnar carrier can be fixed to the base and is arranged in the first reaction chamber by placing or fixing the base.

A wastewater treatment method for treating wastewater with high content of dissolved oxygen using the integrated synchronous nitrogen and sulfur removal device as mentioned above includes the following steps: wastewater enters the first reaction chamber from above the reactor 1, and nitrate in the wastewater is removed, some sulfate and ammonium in the wastewater in the first reaction chamber enter the third reaction chamber for removal, and the residual ammonium in the first reaction chamber flows through the second reaction area and enters the second reaction chamber for removal.

In this embodiment, at the initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

Researches have shown that the biological membrane on the hollow columnar carrier can be grown well by supplementing a carbon source to control ratio of carbon to nitrogen during wastewater treatment, so that it is ensured that the nitrate is completely consumed in the anoxic area, and the nitrate is avoided from entering the anaerobic area to affect sulfate radical reduction.

In this embodiment, wall thickness d of the hollow columnar carrier 4 and hydraulic retention time t of the wastewater in the anoxic area should meet the following requirement: d is greater than or equal to Kt, wherein d is in cm, t is in h, K is a constant in cm/h, and taken as 5.

The integrated synchronous nitrogen and sulfur removal device is used to treat wastewater. The wall thickness of the hollow columnar carrier is 4 cm, the concentration of ammonium in the influent wastewater is 14 mg/L, the concentration of nitrate is 28 mg/L, the concentration of sulfate is 150 mgS/L, and the concentration of dissolved oxygen is 8 mg/L (the above concentrations each are significantly higher than those of ammonium and nitrate in the wastewater of the actual circulating aquaculture system). The hydraulic retention time of the wastewater in the anoxic area is 0.75 h. During stable operation of the system, the ratio of carbon to nitrogen in the anoxic area is controlled to be 4.5:1, the concentration of sulfide in the anaerobic area is stable at 30-60 mg/L, the concentration of nitrate in effluent wastewater of the anoxic area is 0 (that is, nitrate is completely consumed in the anoxic area), and the removal rate of ammonium is 80%. The effluent wastewater is defected, and it is found that the removal rate of ammonium is 95% and removal rate of nitrate is 85%. The average removal rate of sulfate ions is 0.5 mgS/(h·cm²), in a case that voltage of the direct-current power supply is a constant and taken as 2.0 V.

Finally, what needs illustration is that the above embodiments of the present disclosure are only the examples to explain the present disclosure and are not intended to make limitations to the embodiments of the present disclosure. For those skilled in the art, other various variations or modifications may be made on the basis of the above description. It is not possible to list all the embodiments herein. Variations or modifications which are apparently obtained from the technical solution of the present disclosure are still within the scope of protection of the present disclosure.

1. An integrated synchronous nitrogen and sulfur removal device comprising a reactor, wherein a partition plate is horizontally arranged in the reactor to divide the reactor into upper and lower areas, wherein the upper area above the partition plate is a first reaction area, and the lower area below the partition plate is a second reaction area; an annular baffle plate with a height is arranged in the first reaction area, and a lower end of the annular baffle plate is fixed with the partition plate, so that the first reaction area is divided into two chambers, that is, a first reaction chamber and a second reaction chamber from inside to outside; a hollow columnar carrier is arranged in the first reaction chamber, a top end of the hollow columnar carrier is closed, and a lower end of the hollow columnar carrier is fixed with the partition plate, so that a third reaction chamber is formed in the first reaction chamber, and the hollow columnar carrier is made of biological stuffing;
a water inlet of the reactor is formed above the first reaction chamber to facilitate entry of wastewater into the first reaction chamber, and some sulfate and ammonium in the first reaction chamber are diffused into the third reaction chamber, an anode and a cathode are arranged in the third reaction chamber, and the anode and the cathode are connected with positive and negative electrodes of a direct-current power supply, respectively, to facilitate reduction of sulfide produced by sulfate radical reduction into elemental sulfur;
several water holes are formed in portions of the partition plate corresponding to the second reaction chamber and the first reaction chamber corresponding to an outer side of the hollow columnar carrier to facilitate wastewater in the first reaction chamber to enter the second reaction chamber through the second reaction area, aeration equipment is arranged in the second reaction chamber, and a water outlet is formed in an upper part of a side wall of the reactor corresponding to the second reaction chamber to facilitate discharge of treated wastewater.

2. The integrated synchronous nitrogen and sulfur removal device according to claim 1, wherein a corresponding part of the reactor below the partition plate is in an inverted cone shape, a sludge discharge port is formed in a bottom of the reactor for discharging residual sludge in the reactor, and a control valve is arranged at the sludge discharge port for controlling opening and closing of the sludge discharge port.

3. The integrated synchronous nitrogen and sulfur removal device according to claim 1, wherein the second reaction chamber is filled with suspended biological stuffing.

4. The integrated synchronous nitrogen and sulfur removal device according to claim 1, wherein the hollow columnar carrier is arranged in the corresponding first reaction chamber inside the annular baffle plate through a base.

5. A wastewater treatment method for treating wastewater with high content of dissolved oxygen using the integrated synchronous nitrogen and sulfur removal device according to claim 1 comprising following steps: enabling wastewater to enter the first reaction chamber from above the reactor, removing nitrate in the wastewater, enabling some sulfate and ammonium in the wastewater in the first reaction chamber to enter the third reaction chamber for removal, enabling residual ammonium in the first reaction chamber to flow through the second reaction area and enter the second reaction chamber for removal.

6. The wastewater treatment method according to claim 5, wherein at initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

7. The wastewater treatment method according to claim 5, wherein wall thickness d of the hollow columnar carrier and hydraulic retention time t of the wastewater in an anoxic area should meet following requirement: d is greater than or equal to Kt, wherein d is in cm, t is in h, K is a constant in cm/h, and taken as 5.

8. The integrated synchronous nitrogen and sulfur removal device according to claim 5, wherein a corresponding part of the reactor below the partition plate is in an inverted cone shape, a sludge discharge port is formed in a bottom of the reactor for discharging residual sludge in the reactor, and a control valve is arranged at the sludge discharge port for controlling opening and closing of the sludge discharge port.

9. The wastewater treatment method according to claim 8, wherein at initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

10. The wastewater treatment method according to claim 8, wherein wall thickness d of the hollow columnar carrier and hydraulic retention time t of the wastewater in an anoxic area should meet following requirement: d is greater than or equal to Kt, wherein d is in cm, t is in h, K is a constant in cm/h, and taken as 5.

11. The integrated synchronous nitrogen and sulfur removal device according to claim 5, wherein the second reaction chamber is filled with suspended biological stuffing.

12. The wastewater treatment method according to claim 11, wherein at initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

13. The wastewater treatment method according to claim 11, wherein wall thickness d of the hollow columnar carrier and hydraulic retention time t of the wastewater in an anoxic area should meet following requirement: d is greater than or equal to Kt, wherein d is in cm, t is in h, K is a constant in cm/h, and taken as 5.

14. The integrated synchronous nitrogen and sulfur removal device according to claim 5, wherein the hollow columnar carrier is arranged in the corresponding first reaction chamber inside the annular baffle plate through a base.

15. The wastewater treatment method according to claim 14, wherein at initial stage of wastewater treatment, ratio of carbon to nitrogen in the wastewater inside the first reaction chamber is controlled to be (13-16):1, and during stable operation, the ratio of carbon to nitrogen in the wastewater inside the first reaction chamber is controlled to be (3-5):1.

16. The wastewater treatment method according to claim 14, wherein wall thickness d of the hollow columnar carrier and hydraulic retention time t of the wastewater in an anoxic area should meet following requirement: d is greater than or equal to Kt, wherein d is in cm, t is in h, K is a constant in cm/h, and taken as 5.
